(19) United States
(12) Patent Application Publication
(10) Pub. No.: US 2015/0053309 A1
(43) Pub. Date: Feb. 26, 2015

(54) Knife assembly for a planer head

(71) Applicants: Yu-Kun Chen, Taichung (TW); Lee-Cheng Chang, Taichung (TW)

(72) Inventors: Yu-Kun Chen, Taichung (TW); Lee-Cheng Chang, Taichung (TW)

(21) Appl. No.: 13/974,056

(22) Filed: Aug. 23, 2013

(51) Int. Cl. B27G 13/04

(52) U.S. Cl. CPC B27G 13/04
USPC 144/225

(57) ABSTRACT

A planer head is provided with a cylindrical body; an axis formed through the body; a knife carrier assembly formed with the cylindrical body and including a first knife carrier and second knife carriers circumferentially equally spaced apart, each of the first and second knife carriers including a flat front surface, a flat rear surface, and a curved, intermediate surface; and threaded holes formed on the front surface of each of the first and second knife carries; an elongated first knife including first through holes; second knives each including second through holes; first fasteners driven through the first through holes into the threaded holes to secure the first knife to the front surface of the first knife carrier; and second fasteners driven through the second through holes into the threaded holes to secure the second knives to the front surface of each second knife carrier.

### BACKGROUND OF THE INVENTION

1. Field of the Invention

The invention relates to power planers and more particularly to a knife assembly for a planer head with improved characteristics.

2. Description of Related Art

A thickness planer is a woodworking machine used to create boards that are of an even thickness throughout their length and flat on both surfaces. A typical thickness planer comprises a cutter head containing cutting knives, a set of in feed and out feed rollers for drawing an article of wood through the machine, and a table adjustable relative to the cutter head for controlling the resultant thickness of the article of wood.

A conventional, elongated planer head 100 is shown in FIGS. 1 and 2 and comprises three circumferentially spaced apart knife carriers 110 formed with a cylindrical axis. Each knife carrier 110 is provided with a plurality of spaced knives 120 each secured to the knife carrier 110 by using a screw B. The planer head 100 is placed on an article of wood M for flattening same after being powered. About all portions of the top surface of the article of wood M can be worked by the planer head 100. But the knives 120 of one knife carrier 110 are not aligned with the knives 120 of any adjacent knife carrier 110 when viewing from a front or rear end of a feed direction (indicated by arrow). A plurality of parallel rectangular areas of uneven height are formed on the article of wood M as indicated by lines T due to different smoothing times. Thus, the desired smooth surface of the article of wood M by planing cannot be obtained.

Thus, the need for improvement still exists.

### SUMMARY OF THE INVENTION

It is therefore one object of the invention to provide a planer head comprising, in combination a cylindrical body; an axis formed through the cylindrical body; a knife carrier assembly formed with the cylindrical body and comprising a first knife carrier and a plurality of second knife carriers all being circumferentially equally spaced apart, each of the first and second knife carriers including a flat front surface, a flat rear surface, and a curved, intermediate surface between the front and rear surfaces; and a plurality of threaded holes formed on the front surface of each of the first and second knife carries; an elongated first knife including a plurality of first through holes; a plurality of second knives each including a plurality of second through holes; a plurality of first fasteners driven through the first through holes into the threaded holes to secure the first knife to the front surface of the first knife carrier; and a plurality of second fasteners driven through the second through holes into the threaded holes to secure the second knives to the front surface of each of the second knife carriers; wherein length of the first knife is about equal to that of the cylindrical body; wherein the length of the first knife is greater than that of the second knife; wherein the second knives are spaced apart on each of the second knife carriers; wherein positions of the second knives mounted on one second knife carrier are not completely aligned with that of the second knives mounted on an adjacent second knife carrier so that different portions of an article of wood are worked by the second knives of each of the second knife carriers; and wherein width of a top of the article of wood being planed after one revolution of the cylindrical body is about equal to length of the cylindrical body.

The above and other objects, features and advantages of the invention will become apparent from the following detailed description taken with the accompanying drawings.

### BRIEF DESCRIPTION OF THE DRAWINGS

FIG. 1 is a perspective view of a typical knife assembly for a planer head;

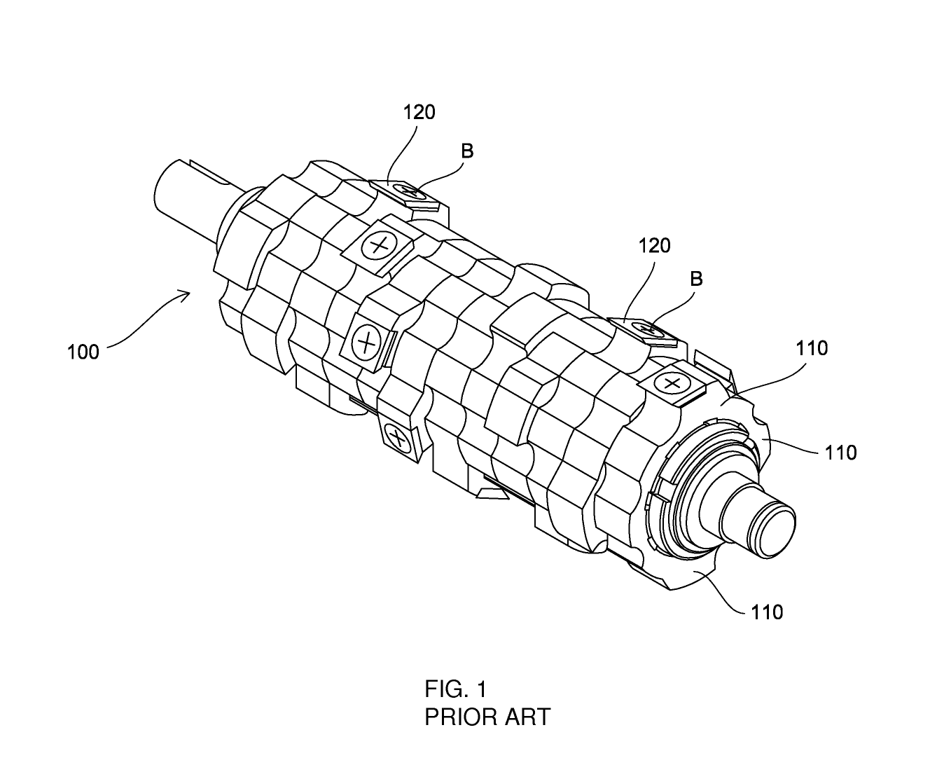

FIG. 2 is a perspective view of the typical knife assembly of FIG. 1 placed on an article of wood in a surface smoothing operation;

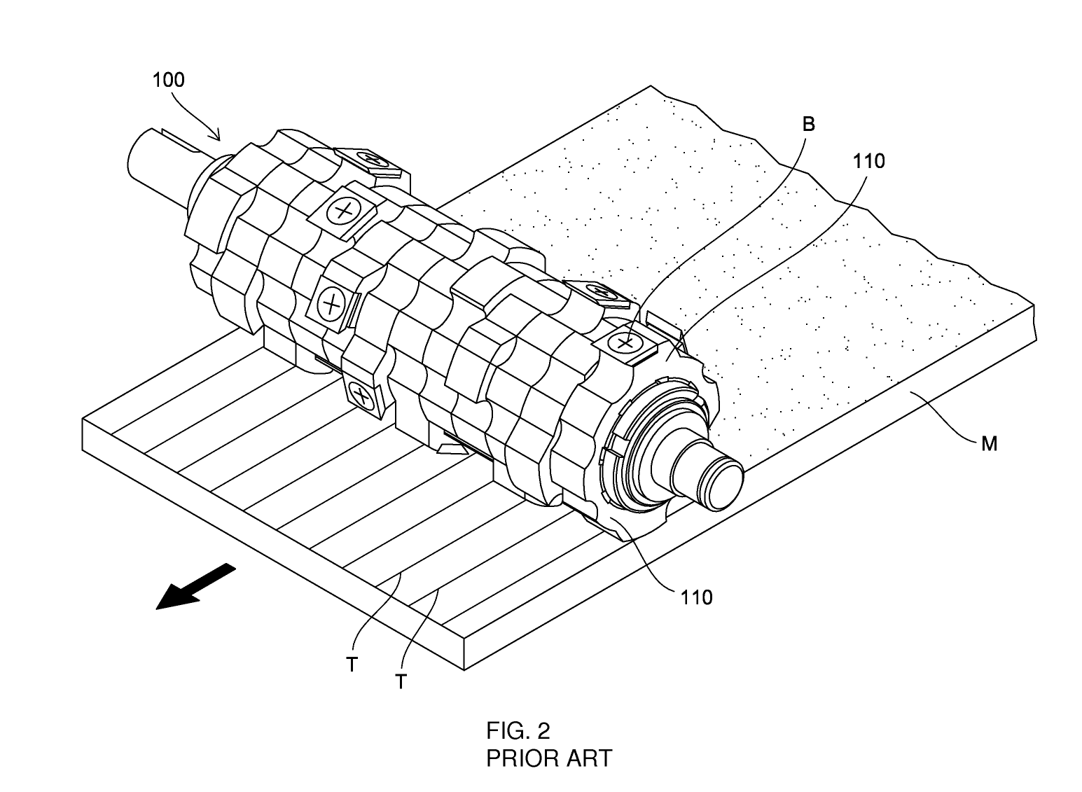

FIG. 3 is a perspective view of a knife assembly for a planer head according to the invention;

FIG. 4 is an exploded view of the knife assembly of FIG. 3;

FIG. 5 is a side elevation of the planer head of FIG. 3 being placed and worked on an article of wood for smoothing its surface; and

FIG. 6 is a perspective view of FIG. 5.

### DETAILED DESCRIPTION OF THE INVENTION

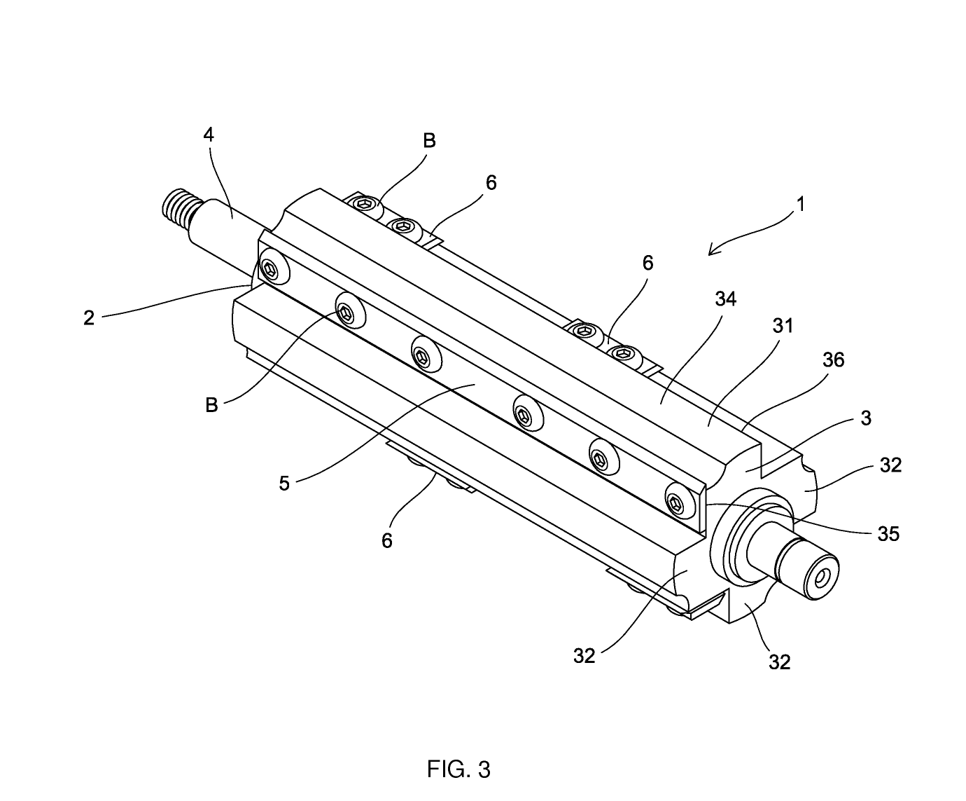

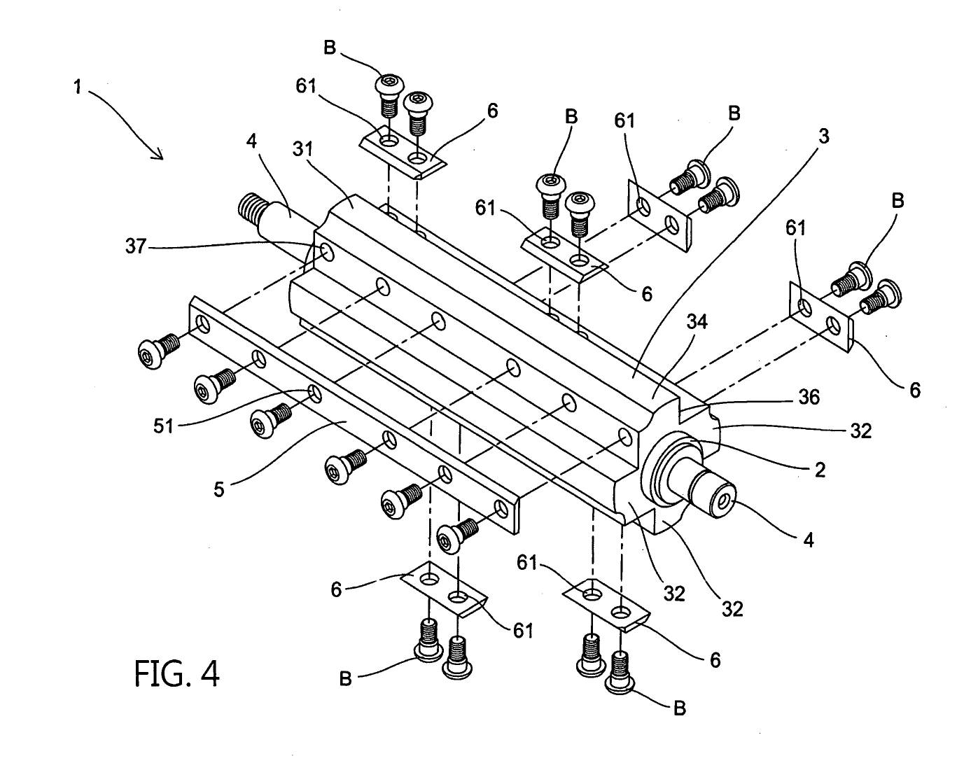

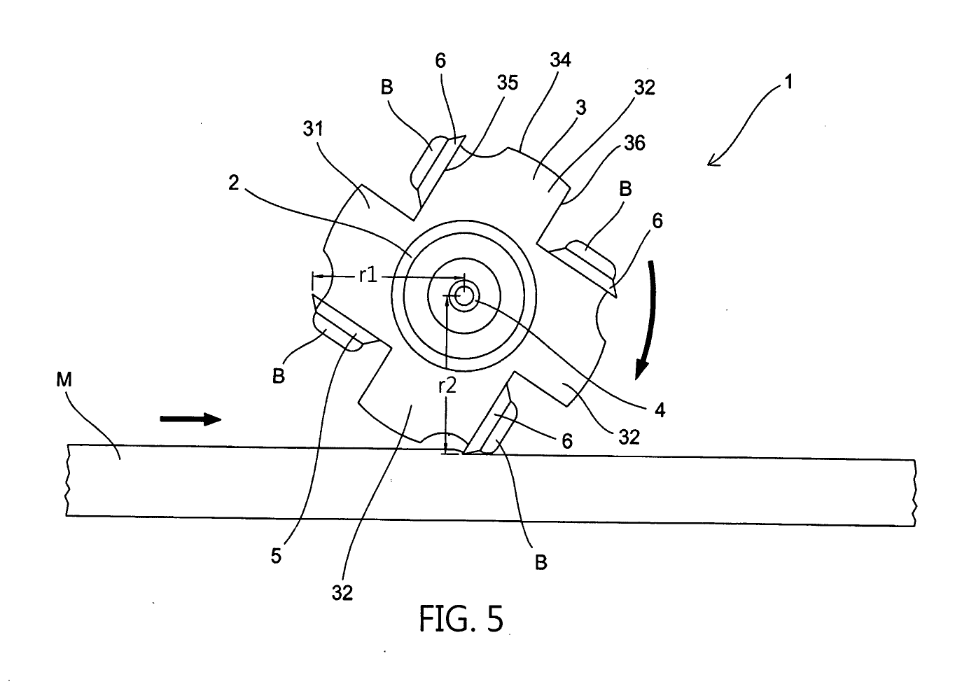

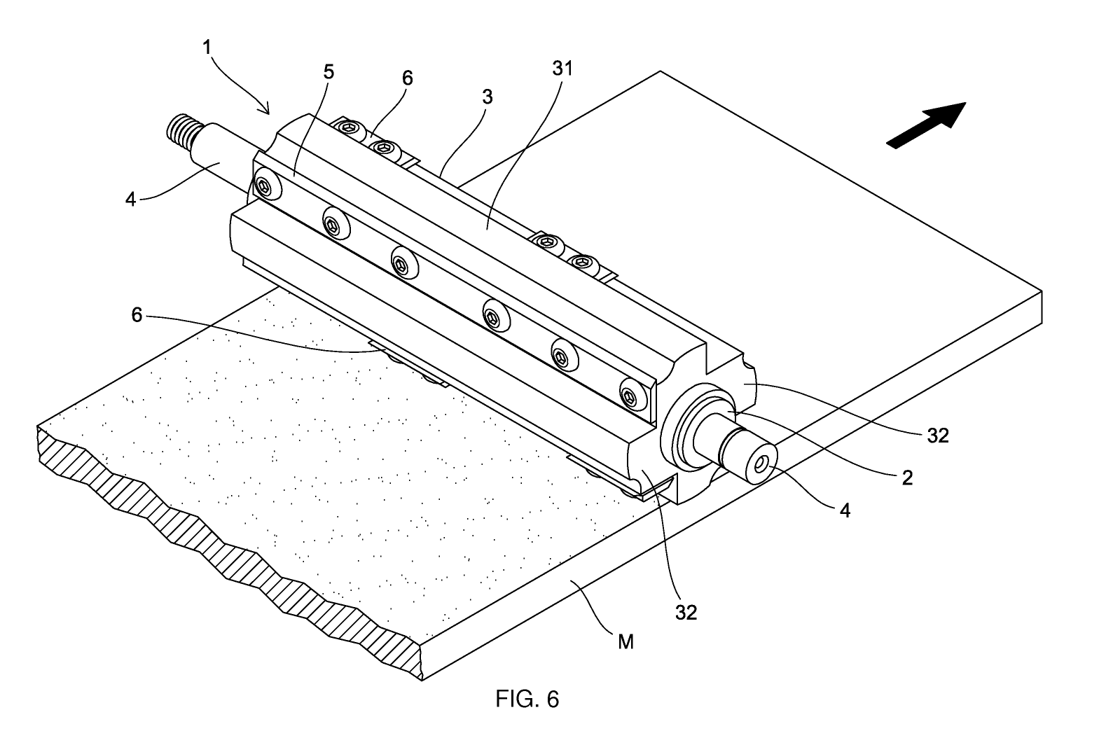

Referring to FIGS. 3 to 6, a planer head 1 in accordance with the invention comprises the following components as discussed in detail below.

A cylindrical body 2 and an axis 4 formed through the body 2 are provided. A knife carrier assembly 3 is formed with the body 2 and provided with a first knife carrier 31 and three second knife carriers 32 circumferentially equally spaced apart on the body 2. Each of the first and second knife carriers 31, 32 comprises a flat front surface 35, a flat rear surface 36, and a curved, intermediate surface 34 between the front and rear surfaces 35, 36. A plurality of threaded holes 37 are provided on the front surface 35 of each of the first and second knife carriers 31, 32. An elongated first knife 5 has a plurality of through holes 51 and a plurality of second knives 6 each have two through holes 61. A plurality of screws B can be driven through the through holes 51 into the threaded holes 37 to secure the first knife 5 to the front surface 35 of the first knife carrier 31 and a plurality of screws B can be driven through the through holes 61 into the threaded holes 37 to secure the second knives 6 to the front surface 35 of each of the second knife carriers 32.

A distance r1 from one cutting edge of the first knife 5 to a center of the axis 4 is less than a distance r2 from one cutting edge of the second knife 6 to a center of the axis 4.

Preferably, the length of the first knife 5 is about the same as that of the body 2.

Preferably, the length of the first knife 5 is greater than that of the second knife 6.

Preferably, the second knives 6 are spaced apart on the second knife carrier 32.

Preferably, positions of the second knives 6 mounted on one second knife carrier 32 are not completely aligned with that of the second knives 6 mounted on an adjacent second knife carrier 32. Thus, different portions of an article of wood M can be worked by the second knives 6 of the second knife carriers 32. It is envisaged by the invention that width of the top surface of the article of wood M being worked by the planer head 1 after one revolution is about the same as the length of the body 2. It is also envisaged by the invention that the second knives 6 are used to roughly plane the surface of the article of wood M and the first knife 5 is used to further smooth the surface of the article of wood M.

While the invention has been described in terms of preferred embodiments, those skilled in the art will recognize that the invention can be practiced with modifications within the spirit and scope of the appended claims.

What is claimed is:

1. A planer head comprising, in combination:
a cylindrical body;
an axis formed through the cylindrical body;
a knife carrier assembly formed with the cylindrical body and comprising a first knife carrier and a plurality of second knife carriers all being circumferentially equally spaced apart, each of the first and second knife carriers including a flat front surface, a flat rear surface, and a curved, intermediate surface between the front and rear surfaces; and a plurality of threaded holes formed on the front surface of each of the first and second knife carries;
an elongated first knife including a plurality of first through holes;
a plurality of second knives each including a plurality of second through holes;
a plurality of first fasteners driven through the first through holes into the threaded holes to secure the first knife to the front surface of the first knife carrier; and
a plurality of second fasteners driven through the second through holes into the threaded holes to secure the second knives to the front surface of each of the second knife carriers;
wherein length of the first knife is about equal to that of the cylindrical body;
wherein the length of the first knife is greater than that of the second knife;
wherein the second knives are spaced apart on each of the second knife carriers;
wherein positions of the second knives mounted on one second knife carrier are not completely aligned with that of the second knives mounted on an adjacent second knife carrier so that different portions of an article of wood are worked by the second knives of each of the second knife carriers; and
wherein width of a top of the article of wood being planed after one revolution of the cylindrical body is about equal to length of the cylindrical body.

2. The planer head of claim 1, wherein the threaded holes are provided on the front surface of each of the first and second knife carriers.

3. The planer head of claim 1, wherein a distance from one cutting edge of the first knife to a center of the axis is less than a distance from one cutting edge of the second knife to the center of the axis.
